(19) United States
(12) Patent Application Publication
(10) Pub. No.: US 2007/0195694 A1
(43) Pub. Date: Aug. 23, 2007

(54) System for dynamic control of an ip network

(76) Inventors: Roland Schutz, Gometz Le Chatel (FR); Joseph Bormans, Mv Almere (NL); Reinhard Mehner, Keltern (DE); Mohamed El Bahri, Hoboken (BE); Knut Lillegraven, Skedsmokorset (NO); Denis Gourlaouen, La Garenne Colombes (FR)

Correspondence Address: LOWE HAUPTMAN & BERNER, LLP, 1700 DIAGONAL ROAD, SUITE 300, ALEXANDRIA, VA, 22314, US

(21) Appl. No.: 10/594,719

(22) PCT Filed: Mar. 16, 2005
(86) PCT No.: PCT/EP05/51201

§ 371 Date: Sep. 29, 2006

(30) Foreign Application Priority Data
Mar. 30, 2004 (FR) 04 03297

(51) Int. Cl. H04L 12/26

(52) U.S. Cl. 370/230

(57) ABSTRACT

System for dynamically controlling equipment in a communication system taking into account the dynamics associated at least with the mobility of the users (authentication and affiliation of services), service quality requests transmitted by the users of the telecommunication network, the availability of the resources of the system comprising at least one control module comprising at least: a control block comprising: a control component ACS adapted to process the authentication of users connected to the network, dynamic configuration of the IP addresses, management of authorizations for service requests from users, configuration of the network components according to the authenticated users, a control component LOC for the process of user affiliation, server mobility, user location and the application-oriented service routing, a control component QSM adapted to process service quality management on the highways of the network. A block comprising one or more of the following elements: the various user services, the network components, connectivity to the external entities.

The invention relates to a system for controlling equipment in a telecommunication network, taking into account in particular the constraints of mobility, security and service quality for users connected to the network and taking into account service quality requests that can be expressed dynamically by a user via a signaling protocol.

The system is notably intended for controlling the equipment present in a network based on the standards of the Internet Protocol (IP) and Ethernet. The equipment consists of for example:
The level 2 switches,
The transmission bearer adaptation functions,
The IP routers,
The firewall systems,
The telephone call management functions,
The message transfer functions,
The content distribution functions.

Numerous models for controlling the switches and routers have been developed in the international organizations or forums, for example IETF (Internet Engineering Task Force), DMTF (Distributed Management Task Force), and so on. These models take into account only the Ethernet switches or routers. They do not take into account the messaging, telephony and content distribution services.

The current configurations implement the IP network management protocol which proposes a model for exchanging rules between network elements designated by the protocol name COPS (Common Open Protocol Service), for communicating between decision points and the application points of the policies for quality of service QoS and for security.

These models are incomplete and do not address all of a telecommunication system which can be deployed over a given geographic area. These models do not take into account mobility, the low availability of the resources, the security architectures, and so on.

One of the aim of the present invention is notably to provide a system capable of controlling, via interfaces designated IP-S, a whole set made up of IP-S components. The term IP-S designates a service-oriented architecture.

The resulting system control plane takes account notably the dynamics present in the telecommunication systems, associated in particular with:
the mobility of the users (authentication and service affiliation),
service quality requests transmitted by the users of the telecommunication network,
the availability of the resources of the system.

The invention relates to a system for dynamically controlling equipment in a communication system, taking into account the dynamics associated at least with the mobility of users. It is characterized in that it comprises at least one control module comprising at least:
a control block comprising:
   a control component ACS adapted to process the authentication of users connected to the network, dynamic configuration of the IP addresses, management of authorizations for service requests from users, configuration of the network components according to the authenticated users,
   a control component LOC adapted to process of user affiliation, server mobility, user location and application-oriented service routing,
   a control component QSM adapted to process the service quality management on the highways of the network.
   a block comprising one or more of the following elements: a component for the various user services, the network components, a component for connectivity to the external entities.

The system according to the invention provides notably the following advantages:
It enables the behavior of telecommunication systems to be controlled according to the users connected, by processing the following functions: authentication and authorization, configuration of the equipment according to the connected users, resource management according to the services requested by the users and mobility.
The components specified by the system do not redefine the existing standard interfaces.
The system control plane automatically configures the network elements according to: the connected users, the available resources, the requests from users for quality of service or QoS and for protection.
The organization of the system control plane according to the invention also allows for the development of specific functionalities not present in the standards and in the equipment conforming to these standards.
The system control plane is generic, it allows for numerous market-standard elements to be controlled (COTS) through the implementation of a generic protocol for controlling the network elements.

Other characteristics and advantages of the present invention will become more apparent from reading the description of an exemplary embodiment, given for illustration and by no means limiting, appended to the figures, which represent:

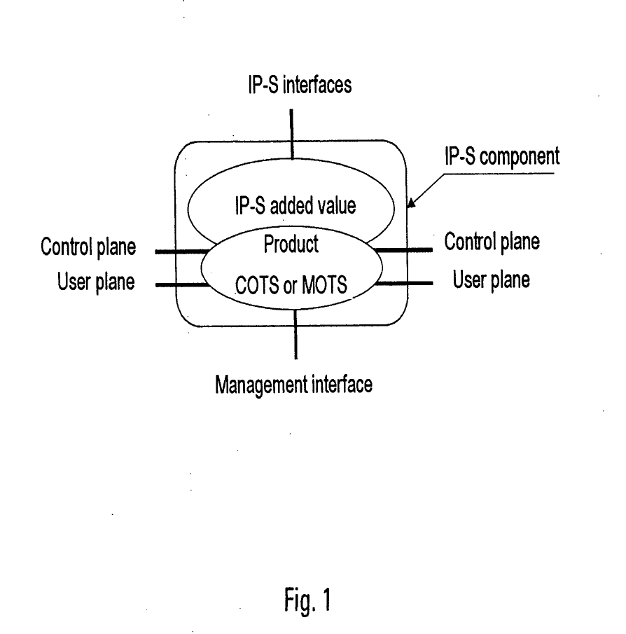

FIG. 1 showing the general organization of an IP-S type component,

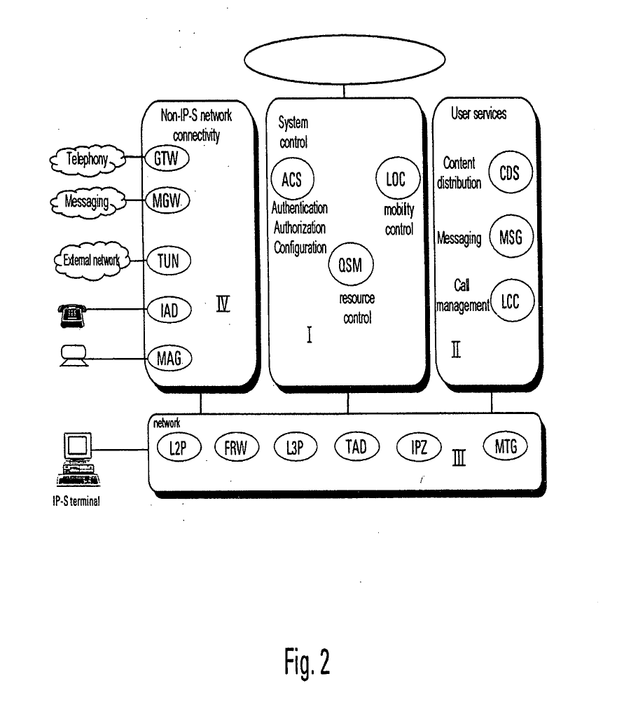

FIG. 2, a diagram of the various functions of the components in the IP-S organization,

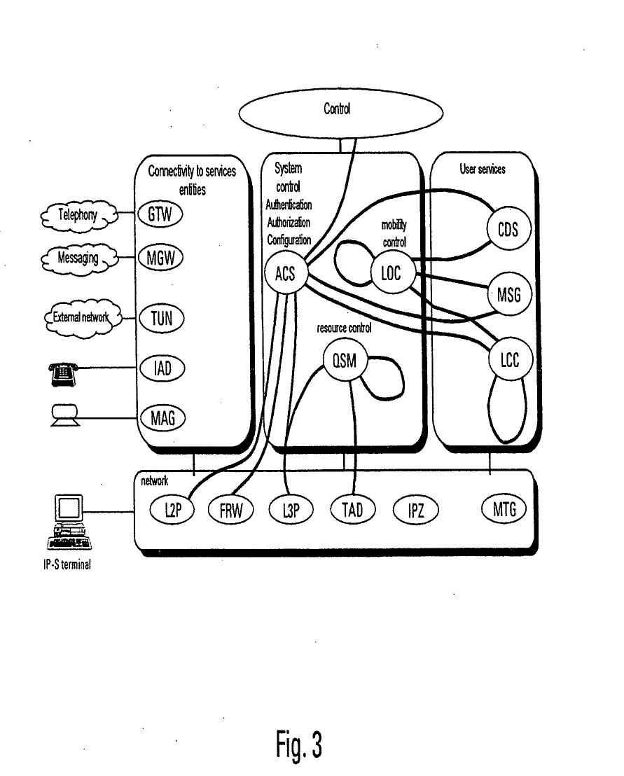

FIG. 3, a diagram showing an example of the IP-S control interfaces,

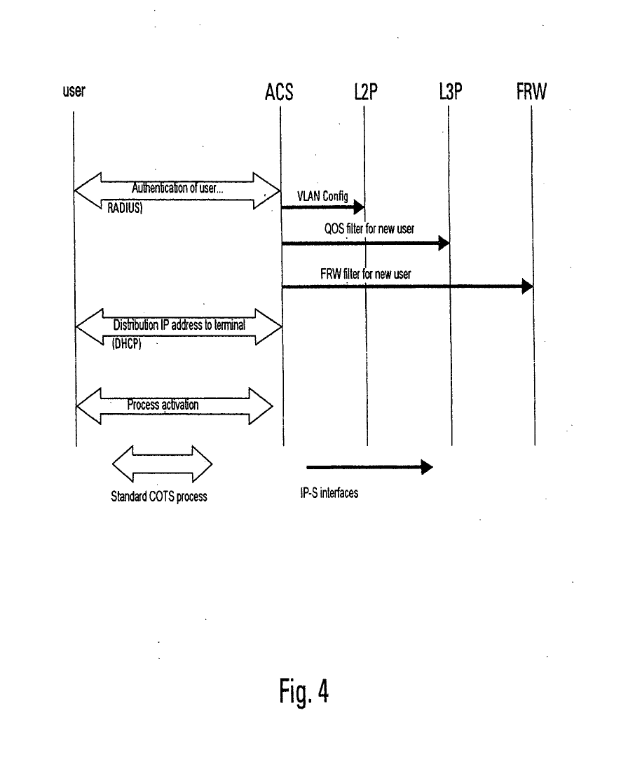

FIG. 4, a diagram of the authentication steps,

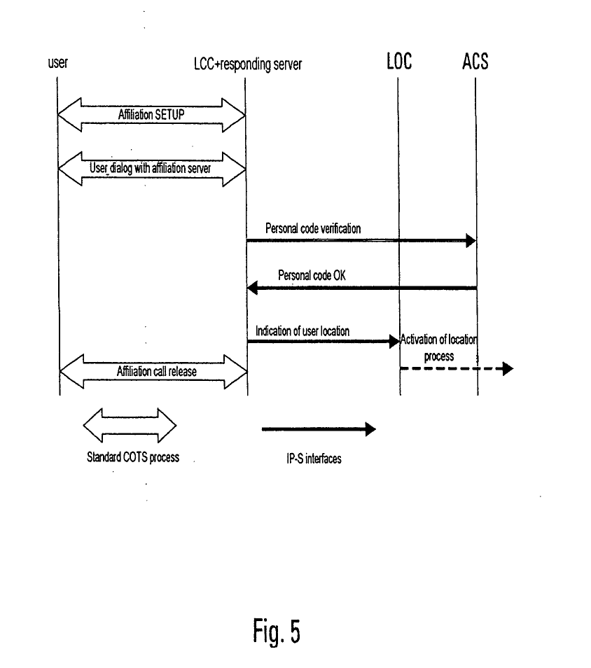

FIG. 5, a diagram of affiliation of a user to the service,

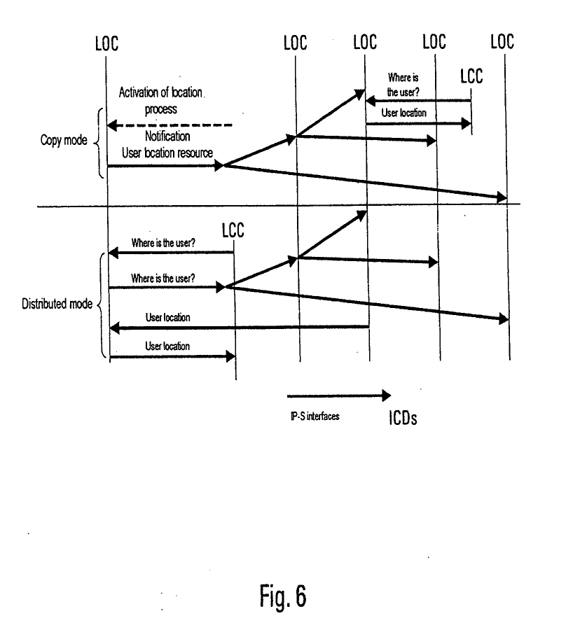

FIG. 6, a flow diagram showing the location mechanisms following the affiliation shown in FIG. 5,

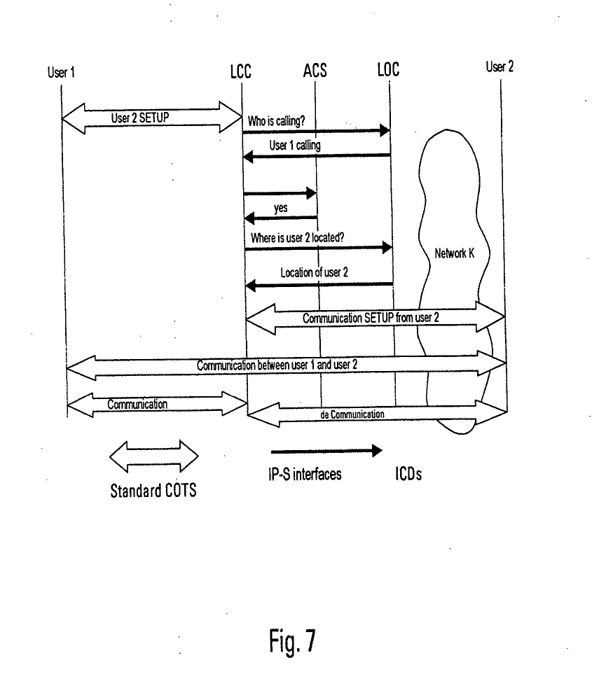

FIG. 7, an example of the procedure for locating a user in a network.

FIG. 1 shows an exemplary general organization of an IP-S component.

The service-oriented components, or IP-S, according to the invention, consist for example:
of a basic market-standard product with interfaces handling the user plane and/or the control plane and presenting a native management interface, an interface that is an integral part of the commercial product,
software, controlled via the IP-S interface, which controls the behavior of the product and which constitutes the IP-S added value. The latter can be of various types:
   control of other components (control of the routing of calls, control of filtering, etc.),
   interfaces with components whose function is to control the system,
   additional features not present in the market-standard elements and meeting a need of a given client, usually described as “add-on” (ad hoc routing, specific management, etc.).

FIG. 2 shows the organization of an IP-S architecture by domain, comprising the following functionalities:
network module (communication, routing, filtering, adaptation to transport over the highways, encryption and also adaptation for message transfer),
user service module (messaging, data distribution and copying, multimedia communication management, etc.),
interconnection with non-IP-S entities,
interconnection with non-IP-S networks (telephony, messaging),
connection of non-IP-S terminals to an IP-S network (telephone, messaging),
interconnection of non-IP-S networks via an IP-S network (tunneling),
system control (resource management QSM, authentication and authorization ACS, mobility management LOC, system configuration according to the connected users).

The architecture of the IP-S system according to the invention relies notably on a breakdown into components, each having a precise definition of the functionalities provided and of the interfaces for interconnecting the components to form a system. This architecture comprises, for example, four blocks, the functionalities of which are detailed later in the description:
a system control block I comprising the ACS module, the LOC module and the QSM module,
a block II comprising the various user services (IP-S components, communication services),
a block III comprising the network components,
a block IV comprising connectivity to non-IP-S entities.
   Presentation of IP-S Service-Oriented Components
   Network Components

The L2P component is responsible for: switching, level 2 quality of service QoS management, so-called “Spanning tree” link management protocols, link aggregation, transmissions from one transmitting point to one receiver, or “unicast” transmissions, and from one transmitter to several receivers, or “broadcast” transmissions, authentication protocols, etc.

The L3P component is responsible for: Unicast routing and routing from one or more transmitters to one or more receivers, or “Multicast”, DiffServ quality of service QoS management, address translations, IP tunnel management, flow redirection, etc.

The FRW component can be used to define secured areas in a network. The component FRW is responsible for filtering at packet level, connection level, and also filtering at application level.

The TAD component specifies the functional adaptations required to transport IP streams over the transport subnetworks (satellite, tactical radio, high speed radio, etc.). These functional adaptations are: stream segmentation and reassembly, QoS management, header compression, highway encryption, etc.

The IPZ component secures the interconnection of classified LANs of the same security level.

The MTG component specifies the functional adaptations required to transport IP-S messages over a non-IP-S network. This component is mainly implemented to transport messages over restricted networks. The protocols implemented are those specified for this type of transport.

Communication Service IP-S Components

The CDS component is responsible for content distribution via restricted core networks. These networks are restricted by the available bandwidth, the high transmission latency, the level of security required on these networks, the transmission error rates, etc. Content distribution covers the real time communication services, transactions for pushing information to the consumer or for going to fetch information from the producer, “Push/Pull”, replication of databases for command and control information systems (C2IS).

The MSG component is responsible for the IP-S messaging system. This system is based on the IETF standards.

The LCC component is responsible for the control of multimedia communications and notably, this component is the application platform for the telephony systems with a view the provision of advanced telephony services.

Components for Interconnection with Non-IP-S Systems

The GTW component is responsible for the interconnection of IP-S speech services with the speech services of other external networks. Call set-up is controlled by the LCC component.

The MGW component is responsible for the interconnection of IP-S messaging services with the messaging services of other external networks (ACP127, or Allied Communication Publication Number 127, MMHS, etc.).

The TUN component supplies a bearer service for interconnecting non-IP-S network elements via an IP-S infrastructure.

The IAD component makes it possible to connect conventional telephone terminals to an IP-S telephony system.

The MAG component allows to connect non-IP-S messaging terminals to an IP-S messaging system. Via the MAG component, these terminals can have access to a mailbox hosted by the MSG component.

Control Components

The control components interact with the components described above, for example, according to the users connected and authenticated, the location of the users, and the service requests from the users.

The control components are:

The ACS component whose function is to process the authentication of the users, connected to the network, the dynamic configuration of the IP addresses, the management of authorizations for service requests from users, the configuration of the components according to the authenticated users (quality of service QoS rules, filtering users, etc.). The ACS component can also be used to control rights of access to and/or use of a service, for example, message transmission. This check can be performed at the transmitting source, at the reception, etc.

The ACS component allows to temporally synchronize each clock in each terminal, and the devices implemented in the network and in data transmission.

The LOC component whose function is to process: the process of affiliation of the users, server mobility, user location and application-oriented service routing.

The QSM component which process the management of quality of service on the highways of the restricted core network: by resource allocation according to the requirements expressed by the network users, and by management of call preemption if more important calls need to be set up.

The interfaces between the components carry the requests and the responses transmitted in the system control plane. These are the IP-S interfaces. These interfaces are used by the control components to control:
operation of the system, that is, configuration of the system according to the connected users (ACS to L2P, L3P, FRW). The database of the users is communicated to the ACS via the ACS Management interface.
the use made of the system by the connected users, in particular:
   controlling the call rights held by the subscribers (via the ACS interfaces to CDS, MSG, LCC).
   locating the users and the servers connecting these users (via the LOC interfaces to CDS, MSG, LCC). The location of the servers and of the users is based on interchanges conducted over the LOC LOC interface.
   the use of the system resources by the users according to the importance of the calls (via the QSM interfaces to L3P, TAD and via the QSM-to-QSM and LCC-to-LCC interfaces).
      IP-S Management

The behavior of the various components is controlled by the interfaces via IP-S. The ACS component is controlled by the manager. The ACS component then controls all other components because it knows the components present in the system, the IP-S configuration of each component, the users that are or could be connected to the network.

Data management is shared in a first step between the network management system and the ACS component which stores the information in a local database.

The information shared with the network management system concerns the service level (user profiles, user groups, etc.) the network level (filtering, etc.) and also the profiles assigned to the components (device profiles, interface configuration, etc.).

In a second step, the information relating to the component level and the network level is transferred to the components via the IP-S interfaces. At this stage, all the components are ready to offer the service to a user.

After each user has been authenticated, the ACS component can, in a third step, configure the specific filtering rules (QoS processing, application filtering, etc.) associated with the users connected to the network.

Authentication Step

The authentication step can be carried out in a number of ways, for example by a unidirectional authentication between a terminal and a server. It can also use mutual authentication between the user and the server.

Network access control is based, for example, on authentication. This makes it possible in particular to know the terminal on which the user is connected.

The identity is checked, for example, on affiliation, on a request for supplementary services, or for access to a mailbox. This is performed, for example, by checking the identity of the user and his password against that stored in the database.

Procedure for Affiliating a User to a Service Offered by the Network

This procedure is shared between the ACS component and the LOC component.

The ACS component is used for authentication/authorization.

The LOC component updates the symbolic address of the user, it notifies the other LOC components of the system of this update and it deletes the old affiliation of the user.

The LOC function can be used at any level. It makes it possible:
At the physical level, to know where a connected terminal is located, where the terminals used by the users are located.
At the network level, to know the IP address of a terminal.
At the service level, to know where a user is located, how to reach a node.

FIGS. 4 to 7 which follow diagrammatically represent the message interchanges between the various equipment of the system.

The device operates, for example, as follows:

Initially, the functions of the devices are registered:
after startup, each device that is part of the system registers its functions with the ACS,
the ACS component checks the identity of the device,
the ACS component stores the point of contact for the device in its database.

The search for the duly registered device can be performed using its generic name, or even by searching for its identifier.

FIG. 4 represents the diagram of dynamic interchanges in a procedure for identifying a user 1. The user can be an individual or a network or server requiring an authorization to connect. This example shows that the network can be adapted to the user connected to the network, regardless of the position of the access point selected by the user.

The user makes an authentication request to the ACS. The ACS checks that the user is registered in its database. It then transmits the information needed to configure the VLAN network to the L2P switch, the filtering and QoS rules to the router L3P for the new user, the filtering rules to the component FRW.

FIG. 5 represents an exemplary procedure for affiliating a user to a telephony service.

The profile of the user describes the specific parameters that could be applied when the user is connected to the network. These parameters are made up of:
generic parameters which can be activated when the user is connected to the network (Quality of service QoS and firewall filter), VLANs (Virtual Local Area Networks).
parameters for each of the services that the user can access. For example, in the case of telephony, the user profile specifies the telephone number, the personal code of the user used for affiliation and for activating telephony-specific services (for example, call transfer), the nearest user groups, the level of precedence for the subscriber, etc.

After the user is connected to the IP-S network, the user can activate his telephone service via the affiliation process. This process requires the user to dial a specific number with his personal code, which is checked by the system before entering into the location process.

FIG. 6 diagrammatically represents an example of flow interchanges in a telephone call.

The following scenario represents the interchanges required for a telephone call. For simplicity, the diagram represents the end of the call.

In the example shown, the user 1 is connected at a position of the LAS of the network, and the user 2 is connected to another LAS. The user 1 uses a conventional protocol to set up the call.

The local call controller, when it receives the call asks the location module LOC “who is calling?”, because this information is stored by the LOC component after affiliation. The LCC component then checks if the user 1 is authorized to place the call.

FIG. 7 diagrammatically represents an exemplary procedure for locating a user on a network.

Two different solutions have been specified in the IP-S system for locating a user, or more generally for locating an application. The information can be replicated in each location server or the information is distributed over the location servers of the network.

1. A system for dynamically controlling equipment in a communication system, taking into account the dynamics associated at least with the mobility of users, characterized in that it comprises at least one control module comprising at least:
a control block comprising:
a control component ACS adapted to process the authentication of users connected to the network, dynamic configuration of the IP addresses, management of authorizations for service requests from users, configuration of the network components according to the authenticated users,
a control component LOC for the process of user affiliation, server mobility, user location and application-oriented service routing,
a control component QSM adapted to process service quality management on the highways of the network.
A block comprising one or more of the following elements: a component for the various user services, the network components, a component for connectivity to the external entities.
